(19) United States
(12) Patent Application Publication
(10) Pub. No.: US 2026/0180465 A1
(43) Pub. Date: Jun. 25, 2026

(54) SINGLE STAGE SEPIC POWER CONVERTER WITH POWER FACTOR CORRECTION

(71) Applicant: Renesas Design (UK) Limited, Bourne End (GB)

(72) Inventors: Jun Zheng, Shenzhen (CN); Wenchao Qian, Shenzhen (CN); Zhi Yang, San Jose, CA (US); Jianming Yao, Cupertino, CA (US); Yong Li, San Jose, CA (US)

(21) Appl. No.: 18/990,670

(22) Filed: Dec. 20, 2024

(51) Int. Cl. H02M 7/219; H02M 1/42; H02M 7/00

(52) U.S. Cl. CPC H02M 7/219; H02M 1/4258; H02M 7/003

(57) ABSTRACT

An isolated SEPIC converter is provided with a power factor correction inductor that couples between an output node from a diode bridge and a terminal of a power switch transistor. When the power switch transistor cycles off, the power factor correction inductor conducts a demagnetizing current through a primary winding of a transformer to charge a bulk capacitor.

### TECHNICAL FIELD

This application relates to a switching power converter, and more particularly to a single-ended primary-inductor converter (SEPIC) power converter with power factor correction.

### BACKGROUND

Battery charging and power management such as through an AC/DC switching power converter is an essential part of systems with rechargeable batteries. An important factor for a switching power converter is its power factor, which is the ratio of its real power to its apparent (complex) power. The power factor is reduced when an AC/DC switching power converter acts as a reactive load (either inductive or capacitive) to the AC power source. In that case, the apparent power is increased, which involves an undesirable oscillation of power between the AC source and the AC/DC switching power converter. The power factor is thus subject to regulation for AC/DC switching power converters having higher output powers such that a relatively high output power AC/DC switching power converter must satisfy a threshold value for its power factor.

For an AC/DC switching power converter to achieve a relatively high-power factor, its input voltage and input current should be in-phase. The input voltage and input currents are in phase when the AC/DC switching power converter presents a purely resistive load to the AC source. However, an AC/DC switching power converter will typically present a reactive load to the AC source. For example, the input impedance of a flyback converter without any power factor correction is largely capacitive and will thus have an unsatisfactory power factor. To improve the power factor, a boost power factor correction stage may be inserted between the rectified AC source and the flyback converter, thus resulting in a two-stage architecture. But a two-stage architecture increases costs such that it is desirable to implement a single-stage isolated (AC to DC) switching power converter. For example, a single-stage flyback converter may use a peak current or a constant on-time methodology for power factor correction. But these single-stage power factor correction (PFC) techniques result in a relatively high output voltage ripple. There is thus a need in the art for power-factor-corrected single-stage isolated switching power converters without a relatively high output voltage ripple.

### SUMMARY

In accordance with an aspect of the disclosure, an isolated switching power converter is provided that includes: an input node for receiving a rectified input voltage; a transformer including a first primary winding having a first terminal coupled to the input node; a power switch transistor coupled to a second terminal of the primary winding; and a power factor correction inductor coupled between the input node and the second terminal of the first primary winding.

In accordance with another aspect of the disclosure, an isolate switching power converter method of operation is provided that includes the acts of: switching on a power switch transistor to magnetize a power factor correction inductor and a primary winding of a transformer; and demagnetizing the power factor correction inductor responsive to switching off the power switch transistor to conduct a demagnetizing current from the power factor correction inductor and through the primary winding to charge a bulk capacitor.

In accordance with yet another aspect of the disclosure, a controller for an isolated SEPIC converter is provided that includes: an input node for receiving a rectified input voltage; a main transformer including a first primary winding having a first terminal coupled to the input node; a power switch transistor coupled to a second terminal of the primary winding; a current sense resistor coupled between ground and the power switch transistor; a power factor correction inductor coupled between the input node and a drain of the power switch transistor; a current sensor configured to sense a power factor correction current conducted by the power factor correction inductor to provide a power factor correction current measurement; and a controller configured to sense a voltage across the current sense resistor to determine a combined current conducted by the power switch transistor, the controller being further configured to subtract the power factor correction current measurement from the combined current to determine a primary winding current conducted by the first primary winding.

Other devices, apparatuses, systems, methods, features, and advantages of the invention will be or will become apparent to one with skill in the art upon examination of the following figures and detailed description. It is intended that all such additional devices, apparatuses, systems, methods, features, and advantages be included within this description, be within the scope of the invention, and be protected by the accompanying claims.

### BRIEF DESCRIPTION OF THE FIGURES

In the figures, like reference numerals designate corresponding parts throughout the different views.

FIG. 1 illustrates a conventional isolated SEPIC.

FIG. 2 illustrates an isolated SEPIC in accordance with an aspect of the disclosure.

FIG. 3 illustrates a modification of the isolated SEPIC of FIG. 2 to reduce the bulk capacitor voltage in accordance with an aspect of the disclosure.

FIG. 4A illustrates some leading-edge-based operating waveforms for the isolated SEPIC of FIG. 3 in accordance with an aspect of the disclosure.

FIG. 4B illustrates some falling-edge-based operating waveforms for the isolated SEPIC of FIG. 3 in accordance with an aspect of the disclosure.

FIG. 5 is a plot of a power factor correction inductor switch on time compensation based upon the bulk capacitor voltage in accordance with an aspect of the disclosure.

FIG. 6A illustrates a portion of an isolated SEPIC in which a power factor correction inductor switch couples directly to ground in accordance with an aspect of the disclosure.

FIG. 6B illustrates a portion of an isolated SEPIC in which a power factor correction inductor switch couples to ground through a dedicated sense resistor in accordance with an aspect of the disclosure.

FIG. 7 illustrates a plot of the rectified AC input voltage, the rectified and filtered AC input voltage, and a power factor correction inductor switch on time compensation at zero crossings of the rectified and filtered AC input voltage in accordance with an aspect of the disclosure.

FIG. 8 illustrates an isolated SEPIC including an auxiliary winding in series with an auxiliary switch transistor and a zero-voltage switching capacitor for zero voltage switching control of the power switch transistor in accordance with an aspect of the disclosure.

FIG. 9 illustrates a portion of an isolated SEPIC in which a power factor correction inductor current is sensed using a current-sensing transformer in accordance with an aspect of the disclosure.

FIG. 10 Embodiments of the present disclosure and their advantages are best understood by referring to the detailed description that follows. It should be appreciated that like reference numerals are used to identify like elements illustrated in one or more of the figures.

### DETAILED DESCRIPTION

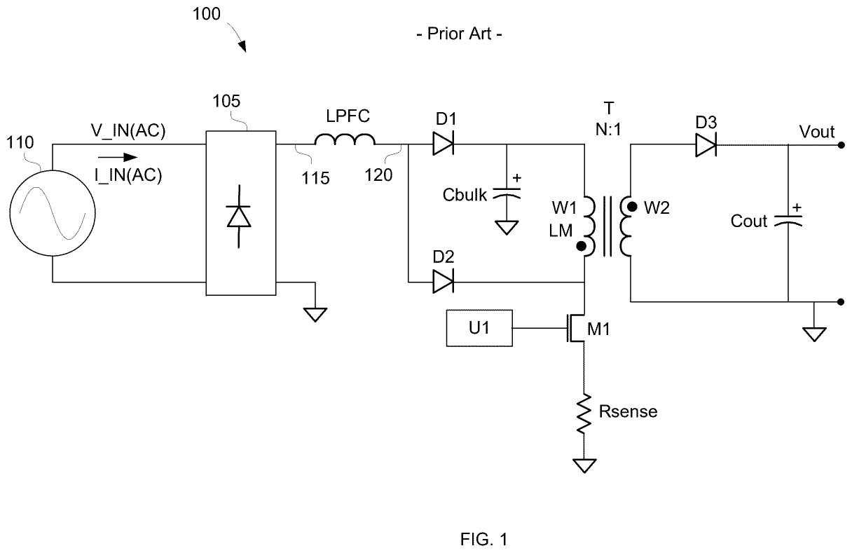

An example prior-art single-stage isolated switching power converter 100 with power factor correction is shown in FIG. 1. A bridge rectifier 105 rectifies an AC source 110 to produce a rectified sinusoidal input voltage (Vin) at an input node 115. A power factor correction (PFC) inductor (LPFC) couples between the input node 115 to an internal node 120 that in turn couples to an anode of a diode D1. A bulk capacitor Cbulk couples between the cathode of the diode D1 and ground. Similarly, a primary winding W1 of a transformer T (note that the transformer T functions as a pair of coupled inductors) couples between the cathode of the diode D1 and a drain of a power switch transistor M1. A source of the power switch transistor M1 couples to ground through a sense resistor Rsense. The internal node 120 also couples to an anode of a diode D2. A cathode of the diode D2 couples to the drain of the power switch transistor M1.

When a controller U1 switches on the power switch transistor M1, both diodes D1 and D2 become forward biased and thus conduct. A magnetizing current will then develop across the power factor correction inductor. Similarly, a magnetizing current will develop across the magnetizing inductance Lm of the primary winding W1 while the power switch transistor M1 conducts. When the power switch transistor M1 switches off, the drain of the power switch transistor M1

rises high to equal a sum of n*Vout and the bulk capacitor voltage. Diode D2 is thus reverse biased and non-conducting while the power switch transistor M1 is off. For the power factor correction inductor to demagnetize, the anode of diode D1 will rise to equal the bulk capacitor voltage (ignoring any threshold voltage drop across diode D1). The demagnetizing voltage difference across the power factor correction inductor in response to the shutoff of the power switch transistor is thus a difference between the bulk capacitor voltage and the input voltage Vin. The demagnetization maintains the bulk capacitor voltage.

An output diode D3 that couples between a secondary winding W2 and an output node for an output voltage Vout is reverse biased while the power switch transistor M1 conducts. But when the power switch transistor M1 switches off, the output diode D3 conducts a secondary winding current to charge an output capacitor Cout with the output voltage. The secondary side of the switching power converter 100 thus functions analogously to a flyback converter with respect to the cycling of the power switch transistor M1.

It is advantageous for the switching power converter 100 to operate in the discontinuous conduction mode in which both the secondary winding current and the power factor correction inductor demagnetize to a zero current. In contrast, the secondary winding current and the power factor correction inductor current may grower higher and higher in a continuous conduction mode of operation. Despite the desirability of maintaining a discontinuous conduction mode of operation, note that the demagnetizing voltage for the power factor correction inductor is just the difference between the bulk capacitor voltage and the input voltage. It is thus difficult for the switching power converter 100 to deliver a sufficient output power yet maintain discontinuous conduction mode operation.

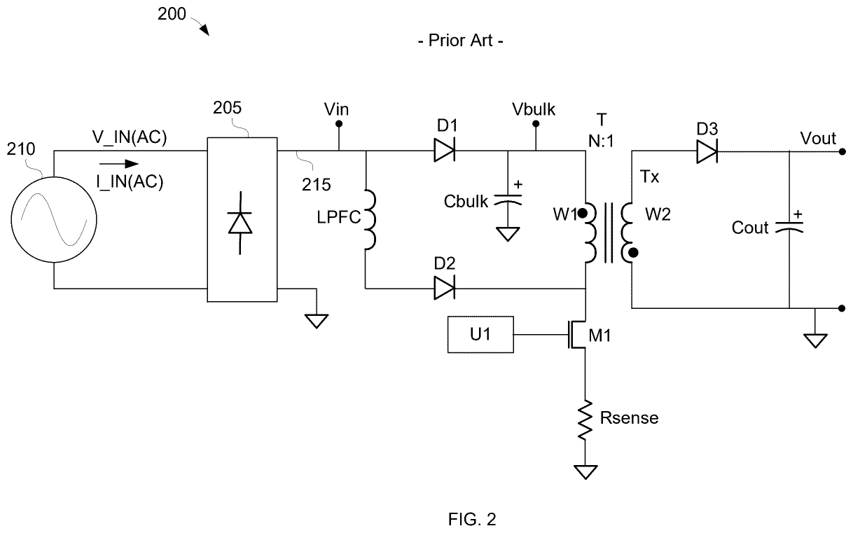

Although not typically described as such, it can be shown that the switching power converter 100 functions as a SEPIC. In contrast, a single-stage switching power converter 200 as shown in FIG. 2 that also functions as a SEPIC achieves a stronger demagnetization of the power factor correction inductor. A discontinuous conduction mode of operation may thus be advantageously maintained despite providing increased output power. As discussed analogously for the switching power converter 100, a bridge rectifier 205 rectifies an AC source 210 to produce a rectified sinusoidal input voltage (Vin) at an input node 215 in the switching power converter 200. The power factor correction inductor (LPFC) couples between the input node 215 and an anode of a diode D2 that has a cathode coupled to a drain of a power switch transistor M1. The input node 215 also couples to an anode of a diode D1 that has a cathode coupled to the primary winding W1 of the transformer T (note that the transformer T actually functions as a pair of coupled inductors since the primary and secondary currents do not conduct at the same time). The bulk capacitor (Cbulk) couples between the cathode of the diode D1 and ground. A controller U1 drives a gate voltage of the power switch transistor M1 to control whether the transistor M1 is on or off. For example, the controller U1 can monitor a voltage across a sense resistor Rsense coupled between the source of the power switch transistor M1 and ground to switch off the power switch transistor M1 when a desired peak current has been achieved.

With the power switch transistor M1 being on, both diodes D1 and D2 are forward biased whereas an output diode D3 that couples between the secondary winding W2 and an output node for the output voltage Vout is reverse biased. A magnetizing current thus develops in the power factor correction inductor while another magnetizing current develops in the primary winding W1 with the power switch transistor M1 conducting. When the power switch transistor M1 switches off, the power factor correction inductor demagnetizes by conducting through diode D2 and winding W1 to charge the bulk capacitor. With the power switch transistor M1 switched off, the secondary winding current is then formed not only from the flyback current that had developed across the magnetizing inductance of the primary winding (as multiplied by the N:1 turns ratios between the primary and secondary windings) but also by the forward current conducted by the power factor correction inductor (as multiplied by the turns ratio). The demagnetizing voltage for the power factor correction inductor is thus not only the bulk capacitor voltage but instead a sum of the bulk capacitor voltage and n*Vout. In this fashion, the power factor correction inductor may more strongly demagnetize to strengthen the ability to maintain a discontinuous conduction mode of operation despite providing a relatively high output power.

The arrangement of the power factor correction inductor between the input node 215 and the anode of the diode D2 may also reduce the power factor correction inductor current at the switch-off time of the power switch transistor M1. In addition, the drain-to-source voltage (Vds spike) across the power switch transistor M1 is also reduced at the switch-off time so that a less robust (and thus less expensive) implementation of the power switch transistor M1 may be used. For example, the power switch transistor M1 may have a 650V rating in one implementation of the switching power converter 200. In contrast, switching power converter 100 may need to operate in a continuous conduction mode to provide a sufficient output power. In the continuous conduction mode, the primary winding current grows higher as does the Vds spike such that a more robust (and thus more expensive) voltage rating for the power switch transistor M1 in the switching power converter 100 may be necessary such as an 800V rating.

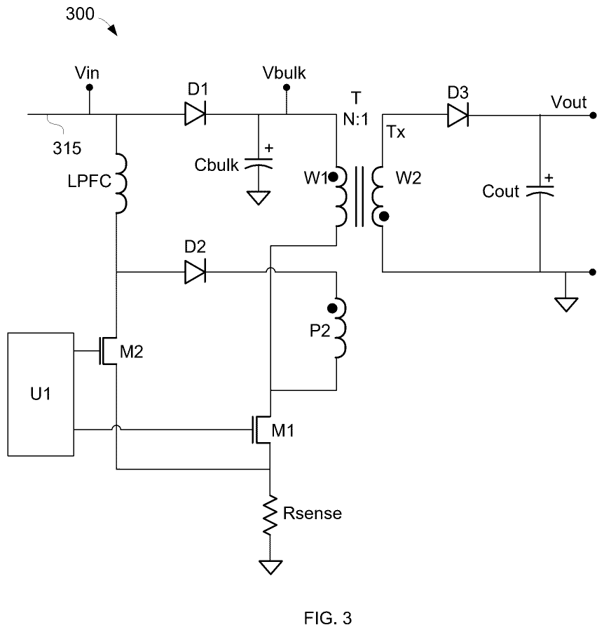

Although the switching power converter 200 advantageously eases the enforcement of a discontinuous conduction mode of operation, the bulk capacitor voltage may grow relatively high (e.g., as high as 450V), which requires a more robust (and thus more expensive) implementation of the bulk capacitor. The switching power converter 200 may be modified as shown for a switching power converter 300 of FIG. 3 to lower the bulk capacitor voltage. The AC input source and the bridge rectifier are not shown in FIG. 3 for illustration clarity but would be arranged as discussed for switching converter 200 to drive an input node 315 with a rectified input voltage Vin. The power factor correction inductor LPFC now couples not only between an input node 315 (which may also be denoted as an output node of the diode bridge) and the anode of the diode D2 but also between the input node 315 and the drain of an NMOS power factor correction inductor transistor M2 having a source coupled to ground through the sense resistor Rsense. The cathode of the diode D2 couples to an auxiliary winding P2 that couples to the drain of the power switch transistor M1. The input node 315 couples through the diode D1 and a primary winding W1 to the drain of the power switch transistor M1. The bulk capacitor, the secondary winding W2, the output diode D3, and the output capacitor Cout are arranged as discussed for the switching power converter 200.

If the power switch transistor M1 is on while the transistor M2 is off, the voltage across the auxiliary winding P2 opposes the input voltage that would otherwise be impressed across the power factor correction inductor. The magnetizing current through the power factor correction inductor will thus be reduced, which in turn limits the increase in the bulk capacitor voltage when the power switch transistor M1 switches off. Cycling the power switch transistor M1 while the transistor M2 is maintained off is thus useful during low load periods to keep the bulk capacitor voltage from excessively increasing. In this fashion, a relatively inexpensive voltage rating (e.g., 400V or less) may be maintained for the bulk capacitor so as to reduce manufacturing costs. Should the transistor M2 be cycled on while the power switch transistor M1 is on, it may be seen that the magnetizing current through the power factor correction inductor is maximized since the power factor correction inductor is charged with the input voltage Vin (minus the sense resistor voltage). In contrast, the power factor correction inductor is only charged with the input voltage Vin minus the auxiliary winding voltage when the power switch transistor M1 is on and the transistor M2 is off. The transistor M2 is also useful with respect to the ringing that occurs with respect to the power factor correction inductor voltage during the zero crossings in the AC input voltage. In particular, the body diode for the transistor M2 will conduct and clamp the lower terminal voltage of the power factor correction inductor should the ringing cause this voltage to be excessively negative.

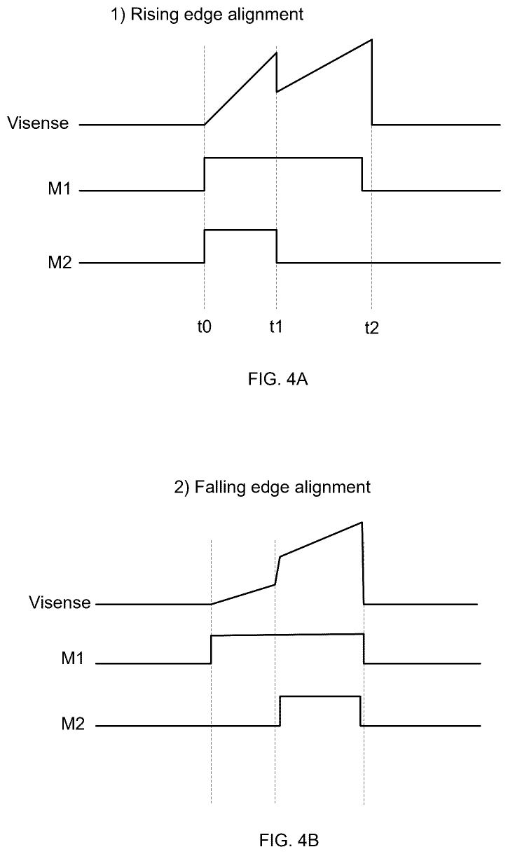

The cycling of the transistor M2 may be controlled in either a rising-edge-aligned methodology or in a falling-edge-aligned methodology. Some example operating waveforms for a rising-edge-aligned control methodology of the transistor M2 are shown in FIG. 4A. At a time t0, the power switch transistor M1 is switched on. A gate voltage of the power switch transistor M1 thus has a rising edge (rising from ground to a power supply voltage) at time t0. The on-time/rising edge of the gate voltage of the transistor M2 is substantially coordinated with the rising edge of the power switch transistor M1 gate voltage at time t0 but with a slight delay to avoid voltage and/or current spikes. At a time t1, the transistor M2 gate voltage has a falling edge (discharge to ground). Finally, the power switch transistor M1 gate voltage has a falling edge at a time t2. The sense resistor voltage Vsense rises at a relatively steep rate from time t0 to time t1 since both the power switch transistor M1 and the transistor M2 are on. From time t1 to time t2, only the power switch transistor M1 is on, which causes the Vsense voltage to rise more slowly. With the Vsense voltage at time t2 indicating that a desired peak primary winding current has been achieved, the controller U1 cycles off the power switch transistor M1.

Some example operating waveforms for a falling-edge-aligned control methodology are shown in FIG. 4B. At a time t0, the power switch transistor M1 is switched on. A gate voltage of the power switch transistor M1 thus has a rising edge (rising from ground to a power supply voltage) at time t0. At a time t2, the controller U1 senses through the Vsense voltage that the desired peak primary winding current has been reached so that it switches off the power switch transistor M1. The gate voltage of the power switch transistor M1 thus has a falling edge (discharge to ground) at time t2. The off time of the transistor M2 is substantially aligned with the off time of the power switch transistor M1. Thus, the controller U1 discharges the gate voltage (induces a falling edge) of the transistor M2 at time t2. At a time t1 following time t0 but before time t2, the transistor M2 gate voltage has a rising edge to switch on the transistor M2. The sense resistor voltage Vsense rises at a relatively lower rate from time t0 to time t1 since only the power switch transistor M1 is on at that time. From time t1 to time t2, both the power switch transistor M1 and the transistor M2 are on, which causes the Vsense voltage to rise more rapidly. With the Vsense voltage at time t2 indicating that a desired peak primary winding current has been achieved, the controller U1 cycles off the power switch transistor M1.

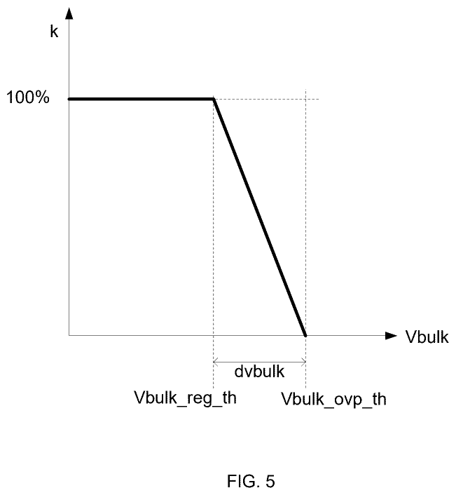

Regardless of whether a rising-edge-based or a falling-edge-based control methodology is implemented, the controller U1 needs to determine the appropriate on-time duration for each cycle of the transistor M2 (assuming that it is not a period of light load in which the cycling of the transistor M2 is suppressed). In one implementation, an on-time (M2_on) of the transistor M2 may be proportional to the on-time (M1_on) of the power switch transistor M1 through a proportionality constant k such that M2_on=k*M1_on. In turn, the proportionality constant k may be determined through a comparison of the bulk capacitor voltage to a threshold voltage (vbulk_reg_th). For example, as shown in FIG. 5, the proportionality constant may equal one so long as the bulk capacitor voltage (Vbulk) is less than the threshold voltage. If the bulk capacitor voltage rises over an over voltage threshold (Vbulk_ovp_th), the proportionality constant is zero. In the range of Vbulk being greater than Vbulk_reg_th but less than Vbulk_ovp_th, the proportionality constant is linearly decreased according to a ratio of (Vbulk−Vbulk_ovp_th)/dvbulk, where dvbulk equals Vbulk_ovp_th−Vbulk_reg_th.

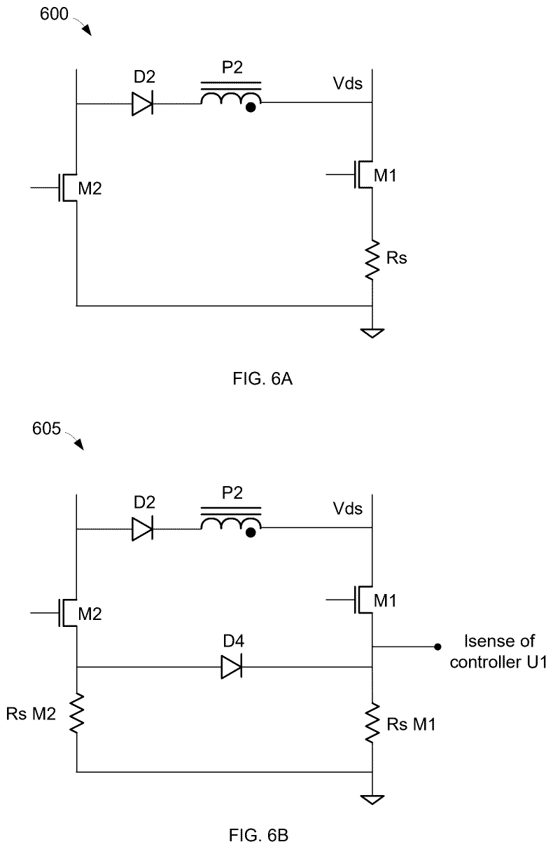

Referring again to the switching power converter 300, note that the current conducted through the transistor M2 will add to the current conducted through the sense resistor Rsense. This may compromise the power factor correction and output voltage regulation since the output voltage regulation is based upon an assumption that the peak primary winding current is proportional to the sense resistor voltage Vsense. The switching power converter 300 may thus be modified as shown for a switching power converter 600 of FIG. 6A. For illustration clarity, only the diode D2, the auxiliary winding P2, the transistor M2, the power switch transistor M1, and the sense resistor Rsense are shown in FIG. 6A. The remaining components of the switching power converter 600 may be arranged as discussed for the switching power converter 300. In the switching power converter 600, the source of the transistor M2 couples directly to ground instead of through the sense resistor. The sense resistor voltage Vsense will thus depend solely on the primary winding current in the switching power converter 600.

Although the sense resistor voltage Vsense in the switching power converter 600 depends only on the primary winding current, it may be beneficial to monitor the current conducted by the transistor M2 such as to detect a fault such as an overcurrent condition. The switching power converter 600 may thus be modified as shown for the switching power converter 605 of FIG. 6B. In switching power converter 605, the source of the transistor M2 couples to ground through a switch transistor sense resistor RsM2. The resistance of the sense resistor RsM2 may be significantly less than the resistance of the sense resistor Rs such that the voltage across the sense resistor RsM2 is much less then sense resistor voltage Vsense during normal operation (no faults). But should a fault develop such as a partial short in the power factor correction inductor that leads to an excess current through the transistor M2, the voltage across the sense resistor RsM2 may be greater than the sense resistor voltage Vsense. This increase in voltage causes a diode D4 that couples between the sources of the transistor M2 and the power switch transistor M1 to become forward biased to trigger an excessive current fault such as sensed by the controller U1 through an Isense pin or terminal.

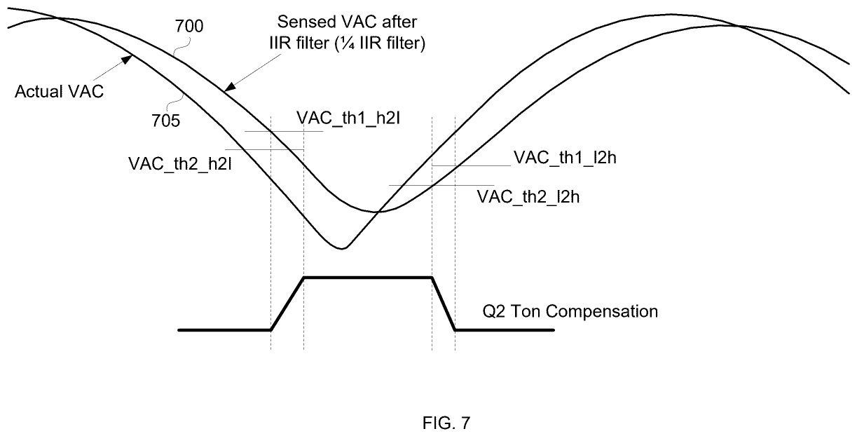

Referring again to the AC source 210, note that the relatively high frequency switching of the power switch transistor M1 could pollute the AC line with switching noise. It is thus conventional that an X capacitor (not illustrated) be coupled between the AC source 210 and the bridge diode 205 to prevent the switching noise from affecting the AC source 210. The X capacitor may then be charged with a relatively high voltage should the switching power converter be decoupled from the AC source 210. It is thus also conventional to monitor whether the switching power converter has been decoupled from the AC source 210 so that the X capacitor may be discharged accordingly. This monitoring of the AC line voltage may be conducted through a low-pass filtering of a full-wave rectified version of the AC line voltage to better detect the zero crossings of the AC voltage cycle. Note that the power factor correction inductor current may resonantly oscillate at these zero crossings. The on-time (M2_on) of the transistor M2 may then be compensated (increased) during the zero crossings so that the power factor correction inductor current is correspondingly increased and thus diminishes the effect of the resonant oscillation that would otherwise occur. Referring now to FIG. 7, an advantageous compensation of the M2 on-time is shown with respect to a filtered and rectified AC line voltage 700 as monitored through a low-pass filter (e.g., an infinite impulse response (IIR) filter). An unfiltered and rectified AC line voltage 705 is also shown for comparison purposes. The controller U1 may monitor the filtered and rectified AC line voltage 700 to determine when the filtered and rectified AC line voltage 700 drops below a first high-to-low threshold voltage (Vac_th1_h2l) as the zero-crossing time is approached. As the filtered and rectified AC line voltage 700 continues to drop below the first high-to-low threshold voltage, the controller U1 may increase the M2 on-time until the filtered and rectified AC line voltage 700 drops below a second high-to-low threshold voltage (VAC_th2_h2l). At that point, the M2 on-time is kept at this maximum compensated value as the zero crossing is passed. The filtered and rectified AC line voltage 700 then begins to rise until it passes a first low-to-high threshold voltage (Vac_th1_l2h). The compensation is then ramped down until it reaches a zero value when the filtered and rectified AC line voltage 700 reaches a second low-to-high threshold voltage (Vac_th2_l2h) that is greater than the first low-to-high threshold voltage.

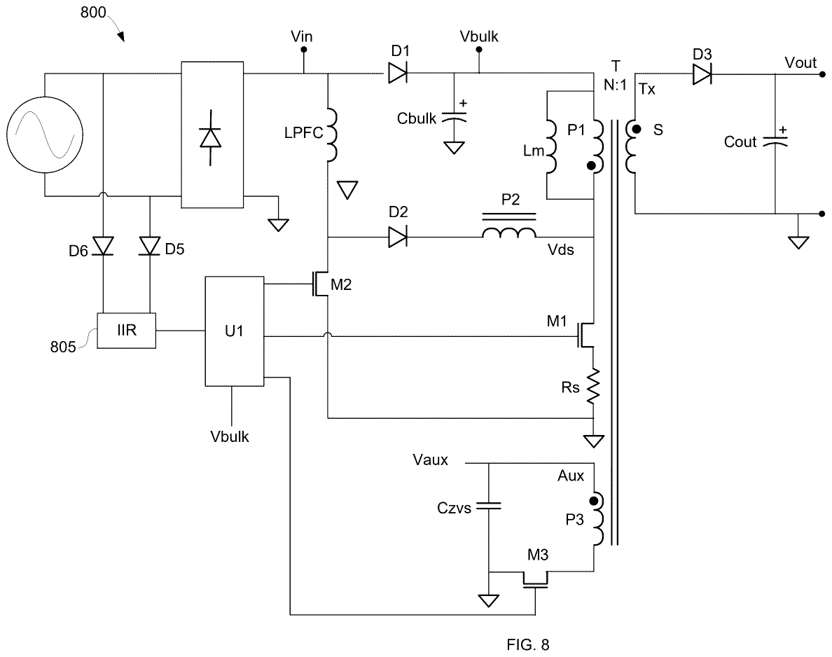

The switching power converter architectures disclosed herein may be advantageously enhanced with a zero-voltage switching control of the power switch transistor M1. An example switching power converter 800 with zero-voltage-switching is shown in FIG. 8. An auxiliary winding P3 magnetically couples to the primary winding P1, the auxiliary winding P2, and the secondary winding S. The auxiliary winding P3 is in series with a capacitor Czvs and a an auxiliary switch transistor M3. The controller U1 controls the switching of the transistor M2, the auxiliary switch transistor M3, and the power switch transistor M1 although it will be appreciated that separate controllers for the switching of these transistors may be used in alternative implementations. An advantageous adaptive control methodology for the switching of the auxiliary switch transistor M3 is disclosed in U.S. Pat. No. 11,437,916, the contents of which are hereby incorporated by reference in their entirety. In a flyback topology, the adaptive control of the on-time (Ton aux flyback) of the auxiliary switch transistor depends on the primary winding magnetizing inductance, the parasitic capacitance of the power switch transistor M1, and a ratio Vin/(N*Vout), where N is the turns ratio. Based upon these factors, the auxiliary switch on-time dependence on the magnetizing inductance and the parasitic capacitance may be expressed as Ton aux flyback=A*Trst/Ton*(B*Tring+C), where Tring is the period of the resonant oscillation of the drain voltage of the power switch transistor following the transformer reset (Trst), and where A, B, and C are coefficients that may be solved for using conventional differential equation techniques. There is a dead time (Twdg flyback) between the cycling off of the auxiliary switch transistor and the switching on of the power switch transistor M1 that may be expressed as Twdg flyback=(D+E*Tring/Ton aux flyback)*(F*Tring+G), where D, E and F are again coefficients that may be solved for using conventional differential equation techniques. But these equations are for the zero-voltage switching in a flyback topology. The control of the auxiliary switch transistor M3 in the switching power converter 800 may follow the same principles as discussed U.S. Pat. No. 11,437,916 except that it is affected by the additional inductance and capacitance from the power factor correction inductor, the transistor M2, the diode D2, and the winding P2. But these factors may be accounted for through an appropriate proportionality constant (coefficient) and an offset that may be configurable such as through a programmable resistor. The on-time (Ton auxiliary SEPIC) for the auxiliary switch transistor M3 may thus be as expressed as Ton auxiliary SEPIC=(Ton aux flyback)*coefficient+offset. Similarly, the dead time (Twdg SEPIC) between the cycling off of the auxiliary switch transistor M3 and the cycling on of the power switch transistor M1 may be expressed as Twdg SEPIC=(Twdg flyback)*coefficient+offset (note that the coefficient and offset for the calculation of Ton auxiliary SEPIC may be independent of the coefficient and offset for the calculation of Twdg SEPIC or they may be same depending upon the implementation). With the resulting zero-voltage switching control of the power switch transistor M1, the switching losses from the cycling of the transistor M2 and from the power switch transistor M1 may be advantageously reduced.

Referring again to the rectified AC input voltage, switching power converter 800 includes a pair of diodes D6 and D5 for its rectification. A low-pass filter 805 (which may be incorporated into the controller U1) low-pass filters the resulting rectified AC input voltage to produce the filtered and rectified AC input voltage that the controller U1 processes to determine whether the low-to-high threshold voltages Vac_th1_h2l and Vac_th2_h2l are satisfied as the filtered and rectified AC input voltage decreases towards a zero crossing. Similarly, the controller U1 may process the filtered and rectified AC input voltage to determine whether the low-to-high threshold voltages Vac_th1_l2h and Vac_th2_l2h are satisfied as the filtered and rectified AC input voltage increases following a zero crossing. Based upon these threshold voltages, the controller U1 may then compensate the transistor M2 on-time as discussed with regard to FIG. 7.

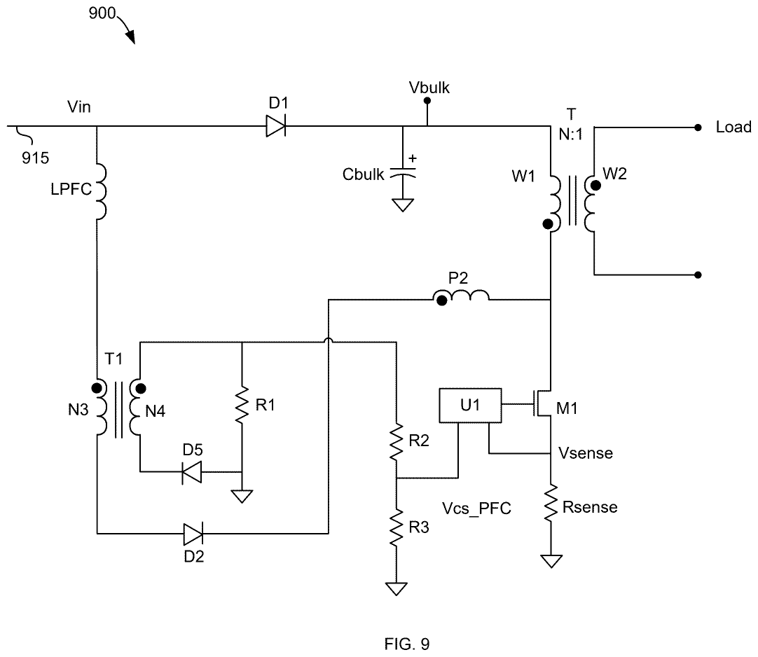

Referring again to the switching power converter 200, note that the peak current conducted through the sense resistor Rsense is a combination of the peak primary winding current and the current conducted by the power factor correction inductor. This same combination occurs in the switching power converter 300 when the transistor M2 is cycled on while the power switch transistor M1 is on. A traditional control methodology for the cycling of the power switch transistor M1 in a flyback topology assumes that the peak current conducted by the sense resistor Rsense is the same as the peak primary winding current. But this is no longer true in the SEPICs 200 and 300. A SEPIC switching power converter 900 is shown in FIG. 9 in which the contribution of the power factor correction inductor current to the peak current sensed at the sense resistor Rsense may be determined through a current sensor. In SEPIC 900, a current-sensing transformer T1 is used to sense the power factor correction inductor current but it will be appreciated that other types of current sensors such as a Hall Effect sensor may be used in alternative implementations. In FIG. 9, the AC input source and the bridge rectifier are not shown for illustration clarity but would be arranged as discussed for switching converter 200 to drive an input node 915 with a rectified input voltage Vin. The power factor correction inductor (LPFC) couples between the input node 915 (which may also be denoted as an output node of the diode bridge) and a first winding N3 of the current-sensing transformer T1. The winding N3 in turn couples to the anode of the diode D2 that has a cathode coupled through the auxiliary winding P2 to the drain of the power switch transistor Q1. The bulk capacitor, the secondary winding W2, the output diode D3 (not shown), and the output capacitor Cout (not shown) are arranged as discussed for the switching power converter 200. Alternatively, the output diode D3 may be replaced by a synchronous rectifier switch.

A current through a second winding N4 of the current-sensing transformer T1 is rectified by a diode D5 has an anode coupled to ground and cathode coupled to a first terminal of the winding N4. A second terminal of the winding N4 couples to ground through a resistor R1. A current Ict conducted by the winding N4 equals a turns ratio N4/N3 times the power factor correction inductor current (IPFC) such that Ict equals (N4/N3)*IPFC, which equals Nct*IPFC (Nct being equal to the turns ratio N4/N3). A voltage at the second terminal of the winding N4 equals a product of the current Ict times the resistance of the resistor R1. This voltage across the resistor R1 is divided by a voltage divider formed by a serial combination of a resistor R2 and a resistor R3 to form a current-sense voltage (VCs_PFC) that equals a ratio of R3/(R2+R3) times the voltage Ict*R1 across the resistor R1. The current-sense voltage Vcs_PFC thus is proportional to the power factor correction inductor current IPFC through a proportionality constant Kr that equals R1*R3*Nct/(R2+R3).

A controller U1 may thus control the cycling of the power switch transistor M1 using any suitable traditional control algorithm by sensing the sense resistor Rsense voltage and subtracting the contribution of the peak power factor correction inductor current as sensed through the sensing of the current-sense voltage Vcs_PFC and dividing the current-sense voltage Vcs_PFC by the proportionality constant Kr to obtain the current IPFC. The resulting control of the SEPIC switching power converter 900 is quite advantageous. For example, if the input voltage Vin at the input node 915 is always below the voltage Vbulk on the bulk capacitor Vbulk, a constant current mode CCM can be eliminated. In addition, a drain-to-source voltage (Vds) spike for the power switch transistor is advantageously under control.

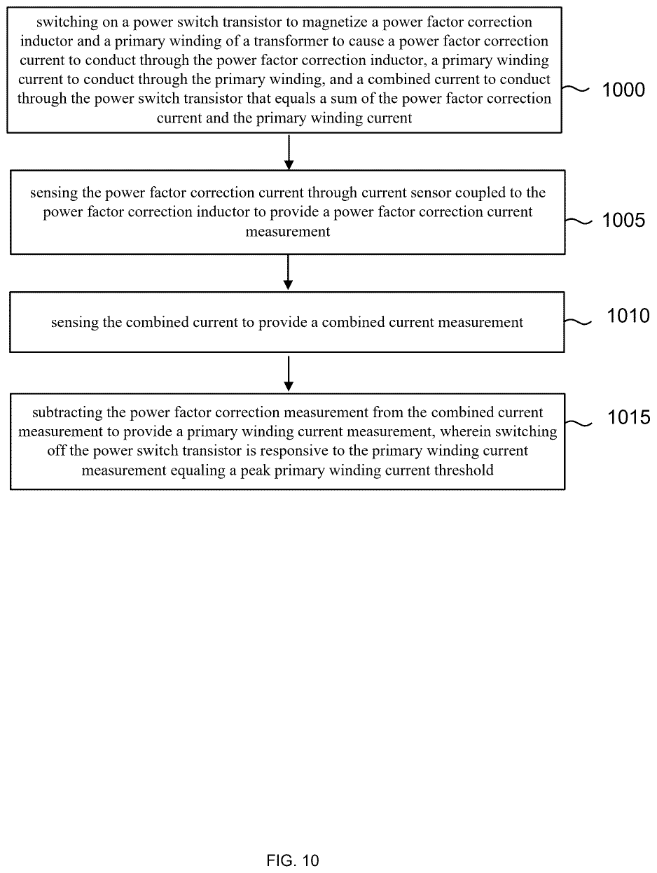

A method of operation for the SEPIC switching power converter 900 will now be discussed with respect to the flowchart of FIG. 10. The method includes an act 1000 of switching on a power switch transistor to magnetize a power factor correction inductor and a primary winding of a transformer to cause a power factor correction current to conduct through the power factor correction inductor, a primary winding current to conduct through the primary winding, and a combined current to conduct through the power switch transistor that equals a sum of the power factor correction current and the primary winding current. The switching on of the power switch transistor M1 in the SEPIC switching power converter 900 that causes a combined current to conduct through the power switch transistor M1 (and thus through the sense resistor Rsense) is an example of act 1000. The method further includes an act 1005 of sensing the power factor correction current through current sensor coupled to the power factor correction inductor to provide a power factor correction current measurement. The sensing of the power factor correction current through the current-sensing transformer T1 is an example of act 1005 but note that a Hall Effect sensor or another suitable current sensor may be used to perform act 1005. The method further includes an act 1010 of sensing the combined current to provide a combined current measurement. The sensing of the sense resistor voltage is an example of act 1010. Finally, the method includes an act 1015 of subtracting the power factor correction measurement from the combined current measurement to provide a primary winding current measurement, wherein switching off the power switch transistor is responsive to the primary winding current measurement equaling a peak primary winding current threshold. The subtraction by the controller U1 in the SEPIC converter 900 is an example of act 1015.

Those of some skill in this art will by now appreciate that many modifications, substitutions and variations can be made in and to the materials, apparatus, configurations and methods of use of the devices of the present disclosure without departing from the scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed:

1. An isolated switching power converter, comprising:
an input node for receiving a rectified input voltage from an AC mains;
a transformer including a first primary winding having a first terminal coupled to the input node;
a power switch transistor coupled to a second terminal of the primary winding; and
a power factor correction inductor coupled between the input node and the second terminal of the first primary winding.

2. The isolated switching power converter of claim 1, further comprising:
a first diode having an anode coupled to the input node and a cathode coupled to the first terminal of the primary winding; and
a second diode having an anode coupled to the power factor correction inductor and a cathode coupled to the second terminal of the primary winding.

3. The isolated switching power converter of claim 1, further comprising:
a bulk capacitor coupled between the first terminal of the primary winding and ground.

4. The isolated switching power converter of claim 3, wherein the transformer includes a second primary winding coupled between the power factor correction inductor and the power switch transistor.

5. The isolated switching power converter of claim 4, further comprising:
a power factor correction inductor transistor coupled between the power factor correction inductor and a primary-side ground.

6. The isolated switching power converter of claim 1, wherein the transformer further includes a secondary winding, the switching power converter further comprising:
an output diode having an anode coupled to a first terminal of the secondary winding; and
an output capacitor coupled between a secondary-side ground and a cathode of the output diode.

7. An isolated switching power converter method, comprising:
switching on a power switch transistor to magnetize a power factor correction inductor and a primary winding of a transformer; and
demagnetizing the power factor correction inductor responsive to switching off the power switch transistor to conduct a demagnetizing current from the power factor correction inductor and through the primary winding to charge a bulk capacitor.

8. The isolated switching power converter method of claim 7, wherein the power switch transistor is switched on for a power switch transistor on time, the method further comprising:
switching on a power factor correction inductor transistor coupled between the power factor correction inductor and ground for at least a portion of the power switch transistor on time.

9. The isolated switching power converter method of claim 8, wherein the switching on of the power factor correction inductor transistor is substantially simultaneous with the switching on of the power switch transistor.

10. The isolated switching power converter method of claim 8, further comprising:
switching off the power factor correction inductor transistor substantially simultaneous with a switching off of the power switch transistor.

11. The isolated switching power converter method of claim 8, further comprising:
determining whether a bulk capacitor voltage of the switching power converter exceeds a an over-voltage threshold voltage; and
suppressing a cycling of the power factor correction inductor transistor responsive to the bulk capacitor voltage exceeding the over-voltage threshold voltage.

12. The isolated switching power converter method of claim 11, further comprising:
decreasing an on time of the power factor correction inductor transistor responsive to the bulk capacitor voltage exceeding a regulation threshold voltage while being less than the over-voltage threshold voltage.

13. The isolated switching power converter method of claim 7, further comprising:
switching on an auxiliary switch transistor coupled to an auxiliary winding of the transformer and to a zero-voltage switching capacitor for an auxiliary switch transistor on time prior to the switching on of the power switch transistor, wherein there is substantially zero voltage across the power switch transistor when the power switch transistor switches on.

14. The isolated switching power converter method of operation of claim 8, further comprising:
filtering a rectified AC input voltage to produce a filtered and rectified AC input voltage;
increasing an on time of the power factor correction inductor transistor responsive to the filtered and rectified AC input voltage dropping below a first threshold voltage as the filtered and rectified AC input voltage decreases towards a zero crossing; and
decreasing an on time of the power factor correction inductor transistor responsive to the filtered and rectified AC input voltage rising above a second threshold voltage after the filtered and rectified AC input voltage increases past the zero crossing.

15. The isolated switching power converter method of claim 7, wherein switching on the power switch transistor to magnetize the power factor correction inductor and the primary winding of the transformer comprises conducting a power factor correction current through the power factor correction inductor, conducting a primary winding current through the primary winding, and conducting a combined current through the power switch transistor that equals a sum of the power factor correction current and the primary winding current, the method further comprising:
sensing the power factor correction current through current sensor coupled to the power factor correction inductor to provide a power factor correction current measurement;
sensing the combined current to provide a combined current measurement; and
subtracting the power factor correction current measurement from the combined current measurement to provide a primary winding current measurement, wherein switching off the power switch transistor is responsive to the primary winding current measurement equaling a peak primary winding current threshold.

16. The isolated switching power converter method of claim 15, wherein sensing the combined current comprising sensing a sense resistor voltage across a sense resistor in series with the power switch transistor.

17. An isolated SEPIC converter, comprising:
an input node for receiving a rectified input voltage;
a main transformer including a first primary winding having a first terminal coupled to the input node;
a power switch transistor coupled to a second terminal of the primary winding;
a current sense resistor coupled between ground and the power switch transistor;
a power factor correction inductor coupled between the input node and a drain of the power switch transistor;
a current sensor configured to sense a power factor correction current conducted by the power factor correction inductor to provide a power factor correction current measurement; and
a controller configured to sense a voltage across the current sense resistor to determine a combined current conducted by the power switch transistor, the controller being further configured to subtract the power factor correction current measurement from the combined current to determine a primary winding current conducted by the first primary winding.

18. The isolated SEPIC converter of claim 17, further comprising:
a first diode; and
an auxiliary winding coupled between a cathode of the first diode and the drain of the power switch transistor, wherein the current sensor comprises:
a current-sensing transformer having a primary winding coupled between the input node and an anode of the first diode;
a first resistor in series with a secondary winding of the current-sensing transformer; and
a voltage divider for dividing a voltage across the first resistor to provide a divided voltage, wherein the controller is further configured to sense the power factor correction current through a sensing of divided voltage.

19. The isolated SEPIC converter of claim 18, further comprising:
a second diode configured to rectify a current conducted by the secondary winding of the current-sensing transformer.

20. The isolated SEPIC converter of claim 19, further comprising:
a third diode having an anode coupled to the input node and a cathode coupled to the primary winding; and
a bulk capacitor coupled between the first terminal of the primary winding and ground.
